(19) United States
(12) Patent Application Publication
(10) Pub. No.: US 2022/0230237 A1
(43) Pub. Date: Jul. 21, 2022

(54) CREDENTIAL PUSH TO CREDIT PUSH NETWORK

(71) Applicant: Eric Solis, Palo Alto, CA (US)

(72) Inventor: Eric Solis, Palo Alto, CA (US)

(21) Appl. No.: 17/575,470

(22) Filed: Jan. 13, 2022

Related U.S. Application Data
(60) Provisional application No. 63/138,099, filed on Jan. 15, 2021.

(51) Int. Cl. G06Q 40/02; G06Q 20/40; G06Q 20/22; G06Q 20/32

(52) U.S. Cl. CPC G06Q 40/02; G06Q 20/3221; G06Q 20/223; G06Q 20/4014

(57) ABSTRACT

A method of enabling secure credit push transactions from a first financial institution to a second financial institution includes generating a credential that includes a bank routing number of the second financial institution and an account number of an account held at the second financial institution, receiving a selection of the first financial institution over a graphical user interface operated by the second financial institution, and, in response to the selection of the first financial institution, prompting a user of the graphical user interface to input login information for accessing an online account associated with the first financial institution. The method may further include, in response to the input of the login information, pushing the credential to a server operated by the first financial institution to be stored in an external account module of the first financial institution.

### CROSS-REFERENCE TO RELATED APPLICATIONS

The present application claims priority to U.S. Provisional Patent Application Ser. No. 63/138,099, filed Jan. 15, 2021 and entitled Credential Push To Credit Push Network, the disclosure of which is incorporated by reference herein in its entirety.

### STATEMENT RE: FEDERALLY SPONSORED RESEARCH/DEVELOPMENT

Not Applicable

### BACKGROUND

External transfers, i.e., transfers from an account at one financial institution to an account at another, introduce an unavoidable complexity in our everyday payment activities. Even for the simplest case of sending money to oneself, the current technology for pushing the funds from one bank to the other necessitates a burdensome multi-step process. For example, one typical process involves the manual entry by the user of routing and account numbers associated with the recipient account, the inspection of the records of the recipient account for a series of microdeposits, and the verification of the amounts of these microdeposits. For the convenience of users, the process typically must only be undertaken once for each external account, after which the external account has been added and recurring transfers can be made to that same account going forward. However, the process of adding the external account in the first place remains fraught with the potential for human error, in addition to being inconvenient and time-consuming (verification by microdeposits typically takes up to four business days). Within the limits of such clunky underlying technology, the efforts of banks to streamline this process have typically consisted only of step-by-step guides and tutorials posted on the bank's website.

For the increasingly common use case of loading funds from a traditional bank to an account held with a mobile application (“app”) based financial service such as a peer-to-peer payment app, there have been some advances in technology to support the pulling of funds to the app from a bank after verification of the user's login information associated with the bank. However, from the perspective of the provider of the app, such “pull” transfers are inferior to “push” transfers in that they afford the bank the right to reverse the transaction for a long period of time thereafter (e.g., several days). As a result, final settlement of the transfer of funds is delayed, forcing the provider of the app either to accept the risk that the transaction will be reversed or to offer suboptimal services to its users in terms of the immediate availability of funds within the app. Moreover, current technology does not adequately address the possibilities for fraud inherent in authorizing pull transactions, such as the possibility that the app turns out to be a fraudulent mechanism for stealing money from the user's bank account or fraud related to the timing of checking fund availability.

### BRIEF SUMMARY

The present disclosure contemplates various systems and methods for overcoming the above drawbacks accompanying the related art. One aspect of the embodiments of the present disclosure is a method of enabling secure credit push transactions from a first financial institution to a second financial institution. The method may comprise generating a credential that includes a bank routing number of the second financial institution and an account number of an account held at the second financial institution, receiving a selection of the first financial institution over a graphical user interface operated by the second financial institution, and, in response to the selection of the first financial institution, prompting a user of the graphical user interface to input login information for accessing an online account associated with the first financial institution. The method may further comprise, in response to the input of the login information, pushing the credential to a server operated by the first financial institution to be stored in an external account module of the first financial institution.

The method may comprise, prior to the receiving of the selection of the first financial institution, storing the credential in a database accessible by a server operated by the second financial institution. The pushing of the credential may include retrieving the credential from the database and pushing the retrieved credential from the server operated by the second financial institution to the server operated by the first financial institution.

The method may comprise, prior to the receiving of the selection of the first financial institution, storing the credential on a device operated by the user. The storing of the credential on the device operated by the user may include storing the credential in an encrypted digital wallet located on the device. The pushing of the credential may include pushing the credential from the device operated by the user to the server operated by the first financial institution.

The graphical user interface may display a list of financial institutions. The selection of the first financial institution may be from the list of financial institutions.

The method may comprise receiving a selection of the account held at the second financial over the graphical user interface. The graphical user interface may display a list of accounts held by the user at the second financial institution. The selection of the account may be from the list of accounts.

The prompting of the user of the graphical user interface to input the login information may include redirecting the user to a URL associated with the first financial institution. The redirecting of the user to the URL associated with the first financial institution may include providing the user with a token to be exchanged with the first financial institution. The redirecting of the user to the URL associated with the first financial institution may include returning a page designated by the URL in a popup window of the graphical user interface.

The generating of the credential may be in response to the input of the login information.

The generating of the credential may be in response to an opening of the account held at the second financial institution.

The graphical user interface may be a graphical user interface of a mobile application operated by the second financial institution. The mobile application may comprise a peer-to-peer payment application. The mobile application may comprise a mobile banking application.

Another aspect of the embodiments of the present disclosure is a non-transitory program storage medium on which are stored instructions executable by a processor or programmable circuit to perform operations for supporting a secure credit push transaction from a first financial institution to a second financial instruction. The operations may comprise generating a credential that includes a bank routing number of the second financial institution and an account number of an account held at the second financial institution, receiving a selection of the first financial institution over a graphical user interface operated by the second financial institution, and, in response to the selection of the first financial institution, prompting a user of the graphical user interface to input login information for accessing an online account associated with the first financial institution. The operations may further comprise, in response to the input of the login information, pushing the credential to a server operated by the first financial institution to be stored in an external account module of the first financial institution.

Another aspect of the embodiments of the present disclosure is a system for supporting a secure credit push transaction from a first financial institution to a second financial institution. The system may comprise a first server operated by the first financial institution. The first server may be operable to receive a credential associated with the second financial institution and store the received credential in an external account module of the first financial institution. The credential may include a bank routing number of the second financial institution and an account number of an account held at the second financial institution. The system may further comprise a second server operated by the second financial institution. The second server may be operable to generate the credential, receive a selection of the first financial institution over a graphical user interface operated by the second financial institution, prompt a user of the graphical user interface to input login information for accessing an online account associated with the first financial institution in response to the selection, and push the credential to the first server in response to the input of the login information.

The system may comprise a user device operable to present the graphical user interface to the user. The selection of the first financial institution and the inputting of the login information may be via the user device.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for enabling secure credit push transactions according to an embodiment of the present disclosure;

FIG. 2 shows an operational flow according to an embodiment of the present disclosure; and

FIG. 3 shows an example sub-operational flow of step 1060 in FIG. 2.

### DETAILED DESCRIPTION

The present disclosure encompasses various embodiments of systems and methods for initiating a credit transaction from a first financial institution serving as an Originating Depository Financial Institution (ODFI) to a second financial institution serving as a Receiving Depository Financial Institution (RDFI). A system as described herein may be referred to as a Credential Push 2 Credit Push (CP2CP) network or may cooperate with a network of financial institutions referred to as a CP2CP network. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

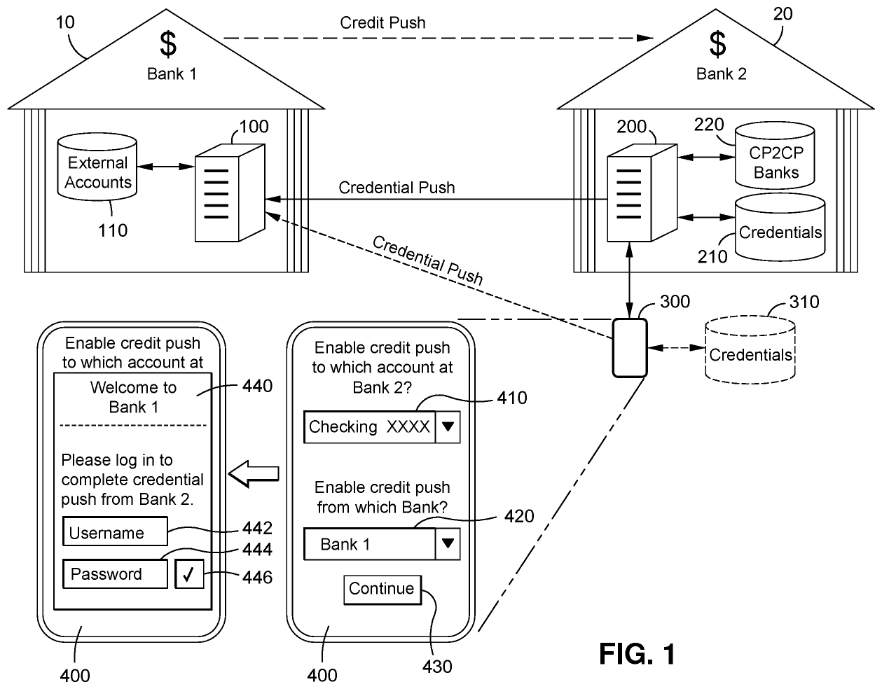

FIG. 1 shows a system for enabling secure credit push transactions according to an embodiment of the present disclosure. The system may enable credit push transactions from a first financial institution 10 (e.g., “Bank 1” in FIG. 1) to a second financial institution 20 (e.g., “Bank 2” in FIG. 1). Either or both of the first and second financial institutions 10, 20, and typically the second financial institution 20 in particular, may be associated with a payment app or other mobile application based financial service. For ease of understanding, to borrow from the terminology associated with a credit push transaction made over the Automated Clearing House (ACH) network, the first financial institution 10 may serve as an Originating Depository Financial Institution (ODFI) while the second financial institution 20 serves as a Receiving Depository Financial Institution (RDFI). By virtue of the system and methods described herein, an account held at the second financial institution 20 may be added as an external account in association with an account held at the first financial institution 10 to enable credit push transactions from the account at the first financial institution 10 to the account at the second financial institution 20. Unlike conventional credit push processes, the disclosed system and method may add the external account in response to a “credential push” to the first financial institution 10 from the second financial institution 20 or from a mobile application associated therewith (see FIG. 1). As such, it is not necessary to verify the RDFI account using microdeposits, nor is it necessary to manually enter routing and account numbers at any step of the process, resulting in a faster process with greatly reduced potential for error. At the same time, because the disclosed system and method enables a push transaction, the risk of fraud and other inadequacies associated with pull transactions are completely avoided.

In relation to the credential push transaction contemplated herein (which enables the later credit push transaction), the second financial institution 20 serving as the RDFI may also be thought of as serving as an Originating Data Financial Institution (ODAFI), that is, the originator of a data transaction performed in advance of the credit push transaction. In particular, a server 200 operated by the second financial institution 20 may create a credential that may be used by the first financial institution 10 or other bank serving as the ODFI to enable credit push transactions to the second financial institution 20 as the RDFI. It is envisioned that the first financial institution 10 and second financial institution 20 may belong to a network of banks or other financial institutions (e.g., a CP2CP network) that participate in the generation and pushing of such credentials to enable credit push transactions. The system may be adopted by existing networks such as the Automated Clearing House (ACH) network, for example. The credential, which may be stored in a credential storage 210 by the server 200, may comprise a bank routing number of the second financial institution 20 and a bank account number of a consumer or other user of the system who has opened an account with the second financial institution 20. For example, the user may have previously opened one or more accounts with the financial institution 20, and a different credential may be generated by the server 200 and stored in the credential storage 210 for each of the user's one or more accounts. The credential storage 210 may likewise store credentials for accounts belonging to other users holding accounts at the second financial institution 20.

When a user wishes to enable secure credit push transactions from the first financial institution 10 to the second financial institution 20, the user may initiate the credential push from the server 200 to a server 100 operated by the first financial institution 10. To this end, the user may interact with a graphical user interface (GUI) 400 operated by the second financial institution 20, such as may be accessible via a web browser or mobile banking application (“app”) installed on a smartphone or other user device 300. As depicted by way of example in the lower portion of FIG. 1, the GUI 400 may allow the user to select one of his/her accounts at the second financial institution 20 (e.g., using a dropdown menu or other account selector 410 following a prompt such as “Enable credit push to which account at Bank 2?”) in order to designate which credential stored in the credential storage 210 to use or which credential to generate. In this regard, it is noted that the credential(s) may be pre-generated at an earlier time (e.g., when the user opens the account, when the user enrolls in a premium banking package or other program that gives access to the CP2CP network, etc.) or, alternatively, may be generated on the fly in response to the user's initiation of the credential push using the GUI 400.

The GUI 400 may further allow the user to make a selection of the first financial institution 10 (e.g., using a dropdown menu or other bank selector 420), which will serve as a Receiving Data Financial Institution (RDAFI) in relation to the credential push and will later serve as the ODFI for the credit push that will be enabled thereby. The GUI 400 may display a list of financial institutions, such as those financial institutions that participate in the CP2CP network, and the user may select the first financial institution 10 from among those listed. The server 200 may populate the list of financial institutions (e.g., to be presented in the dropdown menu or other bank selector 420) from a set of banks stored in a CP2CP banks storage 220, for example. As illustrated, the GUI 400 may prompt the user to make the selection with a prompt such as “Enable credit push from which Bank?” Following the selections made using the bank selector 420 and, if applicable, the account selector 410, the user may then tap or otherwise interact with a “Continue” button 430 to proceed with initiating the credential push.

In response to the selection of the first financial institution 10 and, in some cases, the selection of the user's particular account at the second financial institution 20, the GUI 400 may prompt the user to input login information for accessing an online account associated with the selected first financial institution 10. For example, upon the user's interaction with the “Continue” button 430, the GUI 400 may redirect the user to a URL associated with the first financial institution 10 in order that the user may input the login information. As shown in the example of FIG. 1, the GUI 400 may return a page designated by the URL in a popup window 440 as shown in FIG. 1, where the user may be greeted by the first financial institution 10 (“Welcome to Bank 1. Please log in to complete credential push from Bank 2”) and prompted to enter login information in a username field 442 and password field 444, for example (biometrics, one-time-password, etc. may also be used). Upon tapping or otherwise interacting with an enter (checkmark) button 446, the user's role in initiating the credential push may be complete.

The redirection of the user to the URL associated with the first financial institution 10 may include providing the user with a token to be exchanged with the first financial institution 10. For example, the second financial institution 20 may have previously received a token from the first financial institution 10, and the token may be stored by the server 200 in the CP2CP bank storage 220 in association with the first financial institution 10. When the user enters his/her login information and presses the enter button 446, the token may be appended to the URL (e.g., as a query string) so that the first financial institution 10 (or an intermediary) receives the token from the user device 300. The first financial institution 10 (e.g., the server 100 thereof) or intermediary may then verify the login information of the user, and, if the verification is successful, provide the user device 300 with a signed or otherwise authorized token signifying that the second financial institution 20 may proceed with the credential push to the first financial institution 10. The server 200 (or user device 300) may then include the signed/authorized token as part of the credential push to the server 100 operated by the first financial institution 10.

Upon receiving the credential, which may include the routing number of the second financial institution 20 and relevant account number of the user as described above (and in some cases additional information such as personal identifying information of the account holder, address/contact information of the second financial institution 20, etc.), the server 100 operated by the first financial institution 10 may store the credential in an external account module/storage 110. In this way, the external account may be automatically added on behalf of the user with no need for the user to manually enter routing/account numbers or verify microdeposits. The user may then proceed to initiate credit push transactions from the first financial institution 10 (ODFI) to the authorized account at the second financial institution 20 (RDFI), just as if the external account had been added by conventional processes.

In a case where the user holds multiple accounts at the first financial institution 10, it is also contemplated that the URL destination operated by the first financial institution 10 or intermediary, example contents of which are illustrated in the popup window 440 of the GUI 400, may further allow the user to select a particular account at the first financial institution 10. For example, the user may wish to add the second financial institution 20 as an external account associated with only one of his/her accounts at the first financial institution 10. In some embodiments, however, logging in to the online account of the first financial institution 10 may be enough to authorize the addition of the second financial institution 20 as an external account to all of the user's accounts at the first financial institution 10.

In the above example, it is described that the credential to be pushed to the first financial institution 10 is generated by the server 200 and stored in a credential storage 210, which may include credentials associated with multiple account holders, for example. As another possibility (illustrated in phantom in FIG. 1), it is contemplated that the credential may instead or additionally be stored locally in the user device 300. For example, the credential may be hosted in an encrypted and secure digital wallet 310 awaiting the credential push. This may improve the security of the user's information from the perspective of the user.

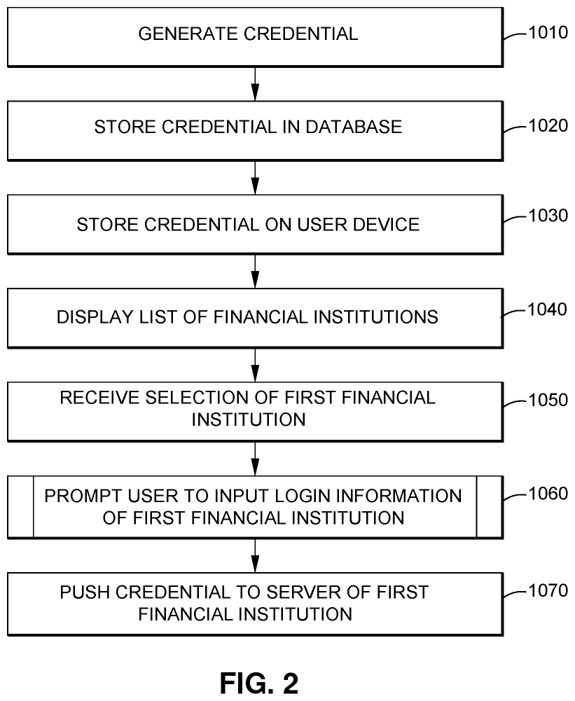

FIG. 2 shows an operational flow according to an embodiment of the present disclosure. Referring to the system shown in FIG. 1 by way of example, the operational flow of FIG. 2 may be performed by the server 200 operated by the second financial institution 20, i.e., the financial institution that will serve as the RDFI of the credit push transaction contemplated herein (and as the ODAFI of the credential push transaction that enables it). The operational flow may begin with the server 200 generating the credential comprising the routing number and account number of the user's account at the second financial institution 20 (step 1010) and storing the credential in a database such as the credential storage 210 (step 1020) and/or on the user device 300 in a secure wallet (step 1030). In a case where the credential is stored in only one or the other of the credential storage 210 and the user device 300, one of steps 1020 and 1030 may be omitted.

When the user would like to enable credit push transactions from the first financial institution 10 to the second financial institution 20, the user may initiate a credential push of the credential using his/her smartphone or other user device 300 (e.g., tablet, laptop computer, desktop computer, etc.). To this end, the server 200 may display a list of financial institutions (step 1040) and receive a selection of the first financial institution 10 from the user (step 1050). For example, the server 200 may communicate with a web browser or mobile application on the user device 300 to present the GUI 400 to the user including the bank selector 420 shown in FIG. 1 (and optionally the account selector 410 for designating a recipient account at the second financial institution 20). The server 200 may populate the bank selector 420 with a list of in-network financial institutions stored in the CP2CP bank storage 220 and may thereafter receive the user's selection via interaction with the bank selector 420. The server 200 may then prompt the user to input login information of the selected first financial institution 10 (step 1060), e.g., by redirecting the user to a URL associated with the first financial institution 10 as illustrated by a popup window 440 in FIG. 1. In general, the server 200 may communicate with the user device 300 to perform the steps of FIG. 2 via the GUI 400 on the user device 300.

In response to the input of the user's login information and, in particular, the subsequent verification thereof by the first financial institution 10 or intermediary, the server 200 may push the relevant credential identifying the routing number of the second financial institution 20 and the account number of the user to the server 100 of the first financial institution 10 (step 1070). The server 200 may directly push the credential from the credential storage 210 to the server 100 or, as described above, the server 200 may push the credential by presenting the user with the GUI 400 that enables the user to initiate the credential push directly from a secure wallet 310 stored on the user device 300 itself to the server 100. Once received by the first financial institution 10, the credential may be stored in an external account module 110 of the first financial institution 10 to enable the envisioned credit push transactions, just as if the user had manually entered routing/account numbers, verified microdeposits, etc., but without the possibility of error or the long delays associated with such conventional methods. The server 100 of the first financial institution 10 may configure the credential for storage as an external account using software code holding unique instructions for integrating with the existing systems of the first financial institution 10. It is contemplated that this may be done using straight-through processing (STP) without human input.

In the example operational flow shown in FIG. 2, steps 1010, 1020, and 1030 precede steps 1040, 1050, and 1060. However, as noted above, the credential need not be pre-generated and may instead be generated on the fly in response to the user's initiation of the credential push using the GUI 400. As such, it is contemplated that step 1010 as well as optionally step 1020 and/or step 1030 may occur after step 1060, with the credential only being generated on an as-needed basis rather than stored in advance. In a case where the credential is generated on the fly and pushed to the first financial institution 10 without being stored by the second financial institution 20, both of steps 1020 and 1030 may be omitted.

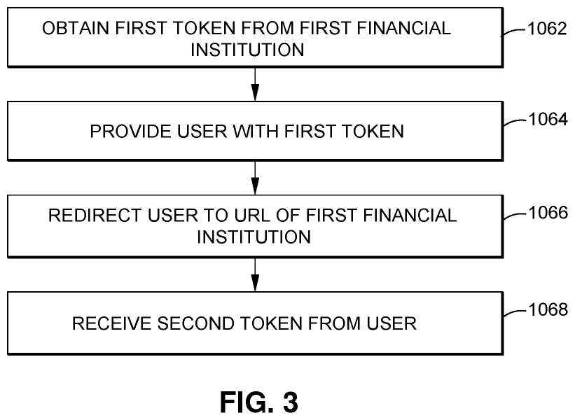

FIG. 3 shows an example sub-operational flow of step 1060 in FIG. 2. The sub-operational flow of FIG. 3 is provided as one example of prompting the user to input login information of the first financial institution 10 on the GUI 400 operated by the second financial institution 20. The sub-operational flow may begin with the server 200 obtaining a first token from the first financial institution 10 or an intermediary (step 1062). The first token may be obtained in advance and stored in association with the first financial institution 10 in the CP2CP bank storage 210, for example, or may be obtained at the time of initiating the credential push (e.g., in response to the user interacting with the “continue” button 430 in FIG. 1). The server 200 may then provide the user with the first token (step 1064) and redirect the user to a URL of the first financial institution 10 or intermediary (step 1066), with the first token being appended to the URL, for example. The purpose of the first token may be to establish, from the perspective of the first financial institution 10 or intermediary, that the user device 300 accessing the URL has done so with authorization from the second financial institution 20 to whom the first financial institution 10 entrusted the first token. By receiving the first token, the first financial institution or intermediary may conclude, for example, that the user device 300 is requesting initiation of a credential push from a known (e.g., CP2CP network) financial institution 20 and that the request is not fraudulent. The server 100 of the first financial institution 10 or intermediary may then validate the user's login information (confirming that the user holds an account with the first financial institution 10) and, if successfully validated, provide the user with a second token authorizing the credential push. The second token may be a new token or it may be an updated version of the first token after has been signed or otherwise modified by the server 100. The second token may then be received from the user device 300 by the server 200 of the second financial institution 20 (step 1068), e.g., via the same app used to initiate the credential push. The second token may then be included with the credential push in step 1070 in order to provide the first financial institution 10 with proof that the credential push was authorized.

With the user's account at the second financial institution 20 (e.g., payment app) having been added as an external account associated with the user's account at the first financial institution 10 (e.g., conventional bank), the user may now initiate credit push transactions from the first financial institution 10 to the second financial institution 20. The user will still need to log into his/her account at the first financial institution 10 to push the credit to the second financial institution 20 as usual, but the setup for doing so will have already happened using the GUI 400 operated by the second financial institution 20, e.g., during account setup with the second financial institution 20 (e.g., in response to an opening of an account at the second financial institution 20). The disclosed systems and methods may advantageously keep all credentials much more secure, eliminate the need for microdeposits or other forms of dual authentication, provide for a much better user experience, and keep the ODFI in control of the transaction, all while protecting the end consumer banking information. Unlike conventional pull transactions from external accounts, there is no opportunity for fraud related to the timing of checking fund availability, nor is the account to be credited an unknown entity from the perspective of the crediting financial institution. At the same time, unlike conventional push transactions to external accounts, there is no need for the consumer to manually add and authorize the external account, reducing the possibility of error and increasing convenience to the consumer.

The functionality described above in relation to the components of the system including the servers 100, 200 and user device 300 shown in FIG. 1, as well as the operational flows described in relation to FIGS. 2 and 3 and those of the mobile applications and GUI 400 described throughout the disclosure, may be wholly or partly embodied in one or more computers including a processor (e.g. a CPU), a system memory (e.g. RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g. over the Internet), such as between the servers 100, 200, between the server 200 and the user device 300, and/or between the server 100 and the user device 300. To the extent that any of the described functionality may be performed at either of the servers 100, 200, it should be noted that either or both of the servers 100, 200 may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of enabling secure credit push transactions from a first financial institution to a second financial institution, the method comprising:
generating a credential that includes a bank routing number of the second financial institution and an account number of an account held at the second financial institution;
receiving a selection of the first financial institution over a graphical user interface operated by the second financial institution;
in response to the selection of the first financial institution, prompting a user of the graphical user interface to input login information for accessing an online account associated with the first financial institution; and,
in response to the input of the login information, pushing the credential to a server operated by the first financial institution to be stored in an external account module of the first financial institution.

2. The method of claim 1, further comprising, prior to said receiving the selection of the first financial institution, storing the credential in a database accessible by a server operated by the second financial institution.

3. The method of claim 2, wherein said pushing the credential includes retrieving the credential from the database and pushing the retrieved credential from the server operated by the second financial institution to the server operated by the first financial institution.

4. The method of claim 1, further comprising, prior to said receiving the selection of the first financial institution, storing the credential on a device operated by the user.

5. The method of claim 4, wherein said storing the credential on the device operated by the user includes storing the credential in an encrypted digital wallet located on the device.

6. The method of claim 4, wherein said pushing the credential includes pushing the credential from the device operated by the user to the server operated by the first financial institution.

7. The method of claim 1, wherein the graphical user interface displays a list of financial institutions and the selection of the first financial institution is from the list of financial institutions.

8. The method of claim 1, further comprising receiving a selection of the account held at the second financial institution over the graphical user interface.

9. The method of claim 8, wherein the graphical user interface displays a list of accounts held by the user at the second financial institution and the selection of the account is from the list of accounts.

10. The method of claim 1, wherein said prompting the user of the graphical user interface to input the login information includes redirecting the user to a URL associated with the first financial institution.

11. The method of claim 10, wherein said redirecting the user to the URL associated with the first financial institution includes providing the user with a token to be exchanged with the first financial institution.

12. The method of claim 10, wherein said redirecting the user to the URL associated with the first financial institution includes returning a page designated by the URL in a popup window of the graphical user interface.

13. The method of claim 1, wherein said generating the credential is in response to the input of the login information.

14. The method of claim 1, wherein said generating the credential is in response to an opening of the account held at the second financial institution.

15. The method of claim 1, wherein the graphical user interface is a graphical user interface of a mobile application operated by the second financial institution.

16. The method of claim 15, wherein the mobile application comprises a peer-to-peer payment application.

17. The method of claim 15, wherein the mobile application comprises a mobile banking application.

18. A non-transitory program storage medium on which are stored instructions executable by a processor or programmable circuit to perform operations for supporting a secure credit push transaction from a first financial institution to a second financial instruction, the operations comprising:
generating a credential that includes a bank routing number of the second financial institution and an account number of an account held at the second financial institution;
receiving a selection of the first financial institution over a graphical user interface operated by the second financial institution;
in response to the selection of the first financial institution, prompting a user of the graphical user interface to input login information for accessing an online account associated with the first financial institution; and,
in response to the input of the login information, pushing the credential to a server operated by the first financial institution to be stored in an external account module of the first financial institution.

19. A system for supporting a secure credit push transaction from a first financial institution to a second financial institution, the system comprising:
a first server operated by the first financial institution, the first server operable to receive a credential associated with the second financial institution and store the received credential in an external account module of the first financial institution, the credential including a bank routing number of the second financial institution and an account number of an account held at the second financial institution; and
a second server operated by the second financial institution, the second server operable to generate the credential, receive a selection of the first financial institution over a graphical user interface operated by the second financial institution, prompt a user of the graphical user interface to input login information for accessing an online account associated with the first financial institution in response to the selection, and push the credential to the first server in response to the input of the login information.

20. The system of claim 19, further comprising a user device operable to present the graphical user interface to the user, wherein the selection of the first financial institution and the inputting of the login information are via the user device.
